(19) United States
(12) Patent Application Publication
(10) Pub. No.: US 2025/0293273 A1
(43) Pub. Date: Sep. 18, 2025

(54) BIPOLAR PLATE BULK MOLDING COMPOUND MATERIAL CHOICE

(71) Applicant: LOCKHEED MARTIN ENERGY, LLC, Grand Prairie, TX (US)

(72) Inventors: Steven John DASILVA, Somerville, MA (US); Curtis S. WARRINGTON, Acton, MA (US); Andrew Joseph MELOUGH, Auburndale, MA (US)

(21) Appl. No.: 18/862,765

(22) PCT Filed: May 9, 2023
(86) PCT No.: PCT/US2023/066756

§ 371 Date: Nov. 4, 2024

Related U.S. Application Data
(60) Provisional application No. 63/339,693, filed on May 9, 2022.

(51) Int. Cl. H01M 8/0258; H01M 8/04186; H01M 8/18

(52) U.S. Cl. CPC H01M 8/0258; H01M 8/04186; H01M 8/188

(57) ABSTRACT

Provided are flow plate assemblies that comprise a flow plate—such as a bipolar plate—disposed within a frame. The frame can include one or more channels or manifolds to distribute active material to channels formed in the flow plate engaged with the frame. The assemblies can themselves be assembled into an electrochemical cell stack.

### CROSS-REFERENCE TO RELATED APPLICATIONS

The present application claims priority to and the benefit of U.S. patent application No. 63/339,693, “Bipolar Plate Bulk Molding Compound Material Choice” (filed May 9, 2022). All foregoing applications are incorporated herein by reference in their entireties for any and all purposes.

### TECHNICAL FIELD

The present disclosure relates to the field of flow batteries and also to the field of bipolar flow plates for use in such batteries.

### BACKGROUND

There exists a long-felt need for safe, inexpensive, easy-to-use, and reliable technologies for energy storage. Large-scale energy storage enables diversification of energy supply and optimization of the energy grid, including increased penetration and utilization of renewable energies. Existing renewable-energy systems (e.g., solar- and wind-based systems) enjoy increasing prominence as energy producers explore non-fossil fuel energy sources. However, storage is required to ensure a reliable, high quality energy supply when sunlight is not available and when wind does not blow.

Electrochemical energy storage systems have been proposed for large-scale energy storage. To be effective, these systems must be safe, reliable, low-cost, and highly efficient at storing and producing electrical power. Flow batteries, compared to other electrochemical energy storage devices, offer an advantage for large-scale energy storage applications owing to their unique ability to decouple the functions of power density and energy density. Existing flow batteries, however, have suffered from the reliance on battery chemistries that result in high costs of active materials and system engineering, low cell and system performance (e.g., round trip energy efficiency), poor cycle life, and others.

Flow battery cells, using separator membranes, can be configured in cell stacks having bipolar separator plates between adjacent cells. These bipolar separator plates are typically made from either a variety of metals, such as titanium and stainless steel, or non-metallic conductors, such as graphitic carbon/polymer composites.

Bipolar separator plates can be made by molding or machining fluid flow fields into a solid sheet of the material. The flow fields can be made up of a series of channels or grooves, generally in serpentine or other flow field patterns, that allow passage of liquids within the bipolar separator plates. In some cases, these patterned plates have porous flow media superposed on them to act as support structures for electrodes, or to act as electrodes themselves, and provide for some degree of fluidic interconnectivity between adjacent channels.

Despite significant development effort, there remains a need in the art for improved flow battery chemistries and systems. In particular, because of the complexity required to manufacture flow fields with these features, framed separator plates are still challenging to produce. The present invention seeks to address some of these deficiencies.

### SUMMARY

In meeting the described long-felt needs, the present disclosure first provides a flow plate assembly, comprising: a flow plate defining a plane, the flow plate comprising a moldable material having a conductive material dispersed therein, and the flow plate comprising one or more first channels configured to communicate a first electrolyte and optionally comprising at least a second channel configured to communicate a second electrolyte; a first frame; and a second frame; the first frame and the second frame being configured to engage with one another with the first frame being associated with a first face of the flow plate and the second frame being associated with a second face of the flow plate, the first frame defining an inlet port configured to communicate the first electrolyte, the first frame further comprising one or more channels or manifolds configured to communicate first electrolyte from the inlet port of the first frame to the first channel of the flow plate, and the first frame and the second frame being configured such that when engaged with one another, a portion of the first surface of flow plate remains exposed.

Also provided is an electrochemical stack assembly, comprising: at least two repeat units, a repeat unit comprising: (a) an electrode assembly, the electrode comprising a porous or otherwise pervious material (e.g., a conductive fabric) disposed within an electrode frame; (b) a first flow plate assembly, the first flow plate assembly comprising a first flow plate disposed within a first flow plate frame, the first flow plate defining a plane and comprising one or more channels configured to communicate a first electrolyte in the plane of the first flow plate or parallel to that plane; and (c) a second flow plate assembly, the second flow plate assembly comprising a second flow plate disposed within a second flow plate frame, the second flow plate defining a plane and comprising one or more channels configured to communicate a second electrolyte in the plane of the second flow plate or parallel to that plane, the electrode assembly being disposed between the first flow plate assembly and the second flow plate assembly such that the one or more channels of the first flow plate are disposed opposite to the one or more channels of the second flow plate assembly, the first flow plate frame and the second flow plate frame being superposed over the electrode frame and the repeat unit being arranged such that a pressure essentially perpendicular to the plane of the first flow plate and to the plane of the second flow plate maintains the first flow plate assembly, the electrode assembly, and the second flow plate assembly in position such that the conductive fabric is permeable to fluid flow.

Additionally disclosed is a method, comprising operating an electrochemical stack according to the present disclosure so as to store electrical energy.

Also provided is a method, comprising operating an electrochemical stack according to the present disclosure so as to provide electrical energy.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 provides an exploded view of an assembly according to the present disclosure;

FIG. 2 provides a cutaway view of a flow plate according to the present disclosure;

FIGS. 3A-3B provide a perspective view of a flow plate and a frame according to the present disclosure;

FIG. 4 provides an exploded view of an arrangement of flow plate assemblies according to the present disclosure from one angle; and

FIG. 5 provides an exploded view of an arrangement of flow plate assemblies according to the present disclosure from an angle opposite to that in FIG. 4.

FIG. 6 provides an illustration of an archetypical flow battery.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

### Flow Battery Background

In this disclosure, various embodiments are described mainly in terms of individual flow batteries. It should be appreciated that, where possible, the descriptions should be read as including flow batteries that are operating or capable of operating with the specified characteristics. Similarly, the descriptions should be read as including systems of flow batteries, wherein the system comprises at least one of the flow plate assemblies described herein.

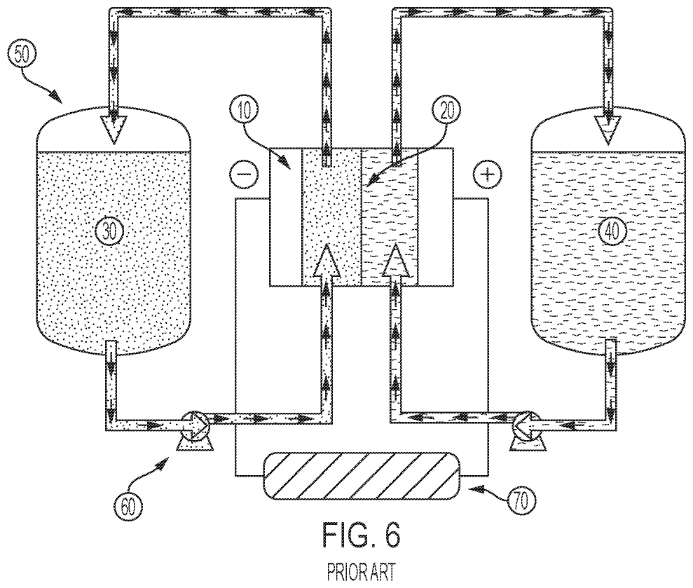

An exemplary flow battery is shown in FIG. 6. As shown in that figure, a flow battery system may include an electrochemical cell that features a separator 20 (e.g., a membrane) that separates the two electrodes of the electrochemical cell. Electrode 10 is suitably a conductive material, such as a metal, carbon, graphite, and the like. Tank 50 may contain first redox material 30, which material is capable of being cycled between an oxidized and reduced state.

A pump 60 may affect transport of the first active material 30 from the tank 50 to the electrochemical cell. The flow battery also suitably includes a second tank (not labeled) that contains the second active material 40. The second active material 40 may or may not be the same as active material 30. A second pump (not labeled) may affect transport of second redox material 40 to the electrochemical cell.

Pumps may also be used to affect transport of the active materials from the electrochemical cell to the tanks of the system. Other methods of effecting fluid transport—e.g., siphons—may be used to transport redox material into and out of the electrochemical cell. Also shown is a power source or load 70, which completes the circuit of the electrochemical cell and allows the user to collect or store electricity during operation of the cell.

It should be understood that FIG. 6 depicts a specific, non-limiting embodiment of a flow battery. Accordingly, devices according to the present disclosure may or may not include all of the aspects of the system depicted in FIG. 6.

As one example, a system according to the present disclosure may include active materials that are solid, liquid, or gas and/or solids, liquids, or gases dissolved in solution or slurries. Active materials may be stored in a tank, in a vessel open to the atmosphere, or simply vented to the atmosphere.

In some cases, a user may desire to provide higher charge or discharge voltages than available from a single battery. In such cases, and in certain embodiments, then, several batteries are connected in series such that the voltage of each cell is additive. An electrically conductive, but non-porous material (e.g., a bipolar plate) may be employed to connect adjacent battery cells in a bipolar stack, which allows for electron transport but prevents fluid or gas transport between adjacent cells.

The positive electrode compartments and negative electrode compartments of individual cells are suitably fluidically connected via common positive and negative fluid manifolds in the stack. In this way, individual electrochemical cells can be stacked in series to yield a desired operational voltage.

In additional embodiments, the cells, cell stacks, or batteries are incorporated into larger energy storage systems, suitably including piping and controls useful for operation of these large units. Piping, control, and other equipment suitable for such systems are known in the art, and include, for example, piping and pumps in fluid communication with the respective electrochemical reaction chambers for moving electrolytes into and out of the respective chambers and storage tanks for holding charged and discharged electrolytes.

The energy storage and generation systems described by the present disclosure may also include electrolyte circulation loops, which may comprise one or more valves, one or more pumps, and optionally a pressure equalizing line. The energy storage and generation systems of this disclosure can also include an operation management system.

The operation management system may be any suitable controller device, such as a computer or microprocessor, and may contain logic circuitry that sets operation of any of the various valves, pumps, circulation loops, and the like.

In some embodiments, a flow battery system may comprise a flow battery (including a cell or cell stack), a first chamber containing the first aqueous electrolyte and a second chamber containing the second aqueous electrolyte; at least one electrolyte circulation loop in fluidic communication each electrolyte chamber, said at least one electrolyte circulation loop comprising storage tanks and piping for containing and transporting the electrolytes; control hardware and software (which may include safety systems); and an optional power conditioning unit. The flow battery cell stack accomplishes the conversion of charging and discharging cycles and determines the peak power of energy storage system, which power may in some embodiments be in the kW range.

The storage tanks contain the positive and negative active materials; the tank volume determines the quantity of energy stored in the system, which may be measured in kWh. The control software, hardware, and optional safety systems suitably include sensors, mitigation equipment and other electronic/hardware controls and safeguards to ensure safe, autonomous, and efficient operation of the flow battery energy storage system. Such systems are known to those of ordinary skill in the art.

A power conditioning unit may be used at the front end of the energy storage system to convert incoming and outgoing power to a voltage and current that is optimal for the energy storage system or the application. For the example of an energy storage system connected to an electrical grid, in a charging cycle the power conditioning unit would convert incoming AC electricity into DC electricity at an appropriate voltage and current for the electrochemical stack. In a discharging cycle, the stack produces DC electrical power and the power conditioning unit converts to AC electrical power at the appropriate voltage and frequency for grid applications.

The energy storage systems of the present disclosure are, in some embodiments, suited to sustained charge or discharge cycles of several hour durations. For example, in some embodiments, the flow batteries of the present invention are capable of retaining at least about 70% efficiency when subjected to 10 charge/discharge cycles. As such, the systems of the present disclosure may be used to smooth energy supply/demand profiles and provide a mechanism for stabilizing intermittent power generation assets (e.g., from renewable energy sources).

It should be appreciated, then, that various embodiments of the present disclosure include those electrical energy storage applications where such long charge or discharge durations are valuable. For example, non-limiting examples of such applications include those where systems of the present disclosure are connected to an electrical grid include, so as to allow renewables integration, peak load shifting, grid firming, baseload power generation consumption, energy arbitrage, transmission and distribution asset deferral, weak grid support, and/or frequency regulation. Cells, stacks, or systems according to the present disclosure may be used to provide stable power for applications that are not connected to a grid, or a micro-grid, for example as power sources for remote camps, forward operating bases, off-grid telecommunications, or remote sensors.

It should be also appreciated that, while the various embodiments described herein are described in terms of flow battery systems, the same strategies and design/chemical embodiments may also be employed with stationary (non-flow) electrochemical cells, batteries, or systems, including those where one or both half cells employ stationary electrolytes. Each of these embodiments is considered within the scope of the present invention.

### Figures

The attached figures and their related descriptions are illustrative only and do not limit the scope of the present disclosure or the appended claims.

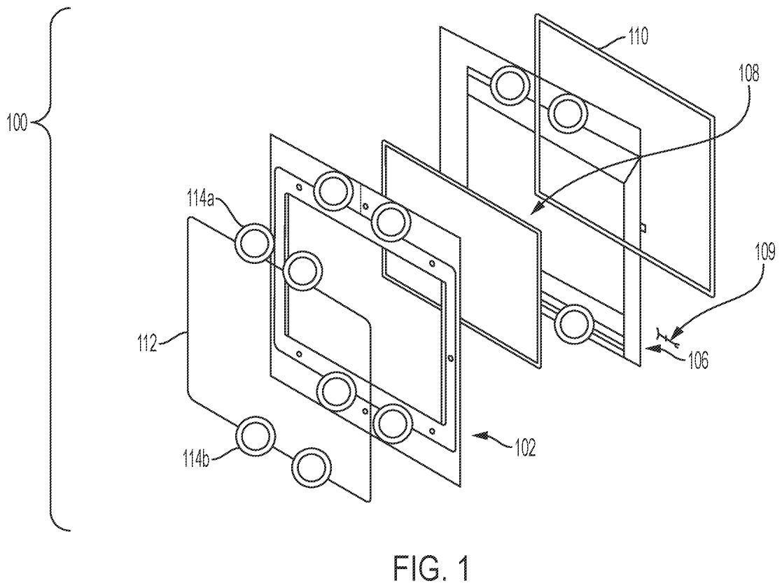

FIG. 1 provides an exploded view of a flow plate assembly 100. As shown, a flow plate assembly can include a flow plate 108, which can include flow channels on one or both faces. Assembly 100 can also include first frame 102 and second frame 106, which first and second frames can be assembled about flow plate 108. Gaskets 112, 114a, and 114b can be used to seal first frame 102. First frame 102 can include one or more grooves, ridges, or other features with which a gasket engages. Similarly, gasket 110 can be used to seal second frame 106. Frame 100 can also include voltage pin 109. As shown, flow plate 108 can include one or more flanges that are sandwiched between or otherwise engaged by first frame 102 and second frame 106.

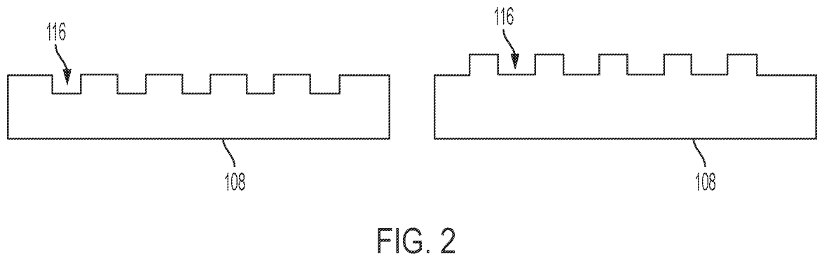

FIG. 2 provides a cutaway view of an example flow plate 108. As shown in the left panel, channels 116 can be formed in the material of flow plate 108 such that the bottom of the channel is beneath the surface of the flow plate 108. Alternatively, as shown in the right panel of FIG. 2, channels can be defined by walls extending from the surface of flow plate 108.

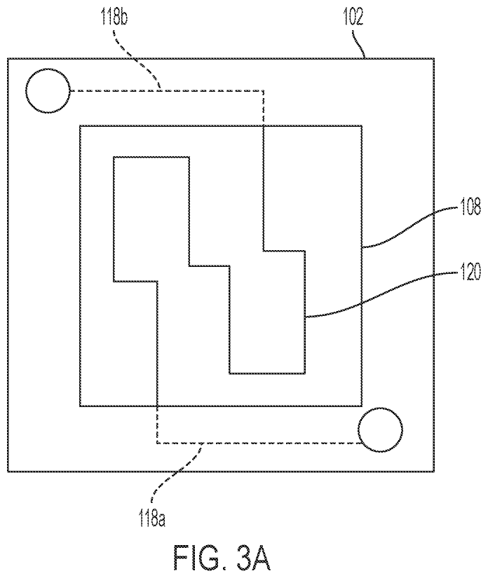

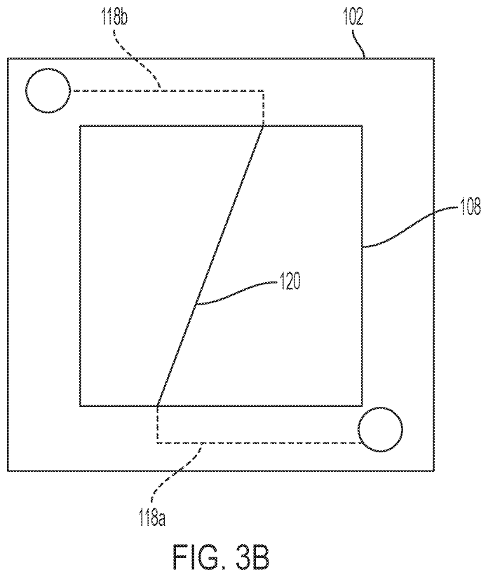

FIGS. 3A-3B illustrate a flow plate 108 engaged with first frame 102. As shown, flow plate 108 can include channel 120. Channel 120 of flow plate 108 can be in fluid communication with channel 118a of first frame 102, which channel 118a can connect an inlet (not labeled) of first frame 102 to channel 120 of flow plate 108. Similarly, channel 118b of first frame 102 can connect channel 120 of flow plate 108 to an outlet (not labeled) of first frame 102.

The total length of the channels of the frame and the channels of the flow plate that are in fluid communication with the channels of the frame can define a flow length. By reference to FIGS. 3A-3B, the flow length is the total length of 118a, 120, and 118b, plus the length of any other channels in the frame that might communicate fluid to channels 118a and 118b.

In some embodiments, of that flow length, at least about 1% of the flow length resides in the channels of the frame. In some embodiments, at least about 5% of the flow length resides in the channels of the frame. In some embodiments, at least about 10% of the flow length resides in the channels of the frame. In some embodiments, at least about 15% of the flow length resides in the channels of the frame. In some embodiments, at least about 20% of the flow length resides in the channels of the frame. In some embodiments, at least about 25% of the flow length resides in the channels of the frame. In some embodiments, at least about 30% of the flow length resides in the channels of the frame. In some embodiments, at least about 35% of the flow length resides in the channels of the frame. In some embodiments, at least about 45% of the flow length resides in the channels of the frame. In some embodiments, at least about 50% of the flow length resides in the channels of the frame. In some embodiments, at least about 55% of the flow length resides in the channels of the frame. In some embodiments, at least about 60% of the flow length resides in the channels of the frame. In some embodiments, at least about 65% of the flow length resides in the channels of the frame. In some embodiments, at least about 70% of the flow length resides in the channels of the frame. In some embodiments, at least about 75% of the flow length resides in the channels of the frame. In some embodiments, at least about 80% of the flow length resides in the channels of the frame. In some embodiments, at least about 85% of the flow length resides in the channels of the frame. In some embodiments, at least about 90% of the flow length resides in the channels of the frame. In some embodiments, at least about 95% of the flow length resides in the channels of the frame.

In some embodiments, from about 1 to about 95% of the flow length resides in the channels of the frame. In some embodiments, from about 5 to about 90% of the flow length resides in the channels of the frame. In some embodiments, from about 10 to about 85% of the flow length resides in the channels of the frame. In some embodiments, from about 15 to about 80% of the flow length resides in the channels of the frame. In some embodiments, from about 20 to about 75% of the flow length resides in the channels of the frame. In some embodiments, from about 25 to about 70% of the flow length resides in the channels of the frame. In some embodiments, from about 30 to about 65% of the flow length resides in the channels of the frame. In some embodiments, from about 35 to about 60% of the flow length resides in the channels of the frame. In some embodiments, from about 40 to about 55% of the flow length resides in the channels of the frame. In some embodiments, from about 45 to about 50% of the flow length resides in the channels of the frame.

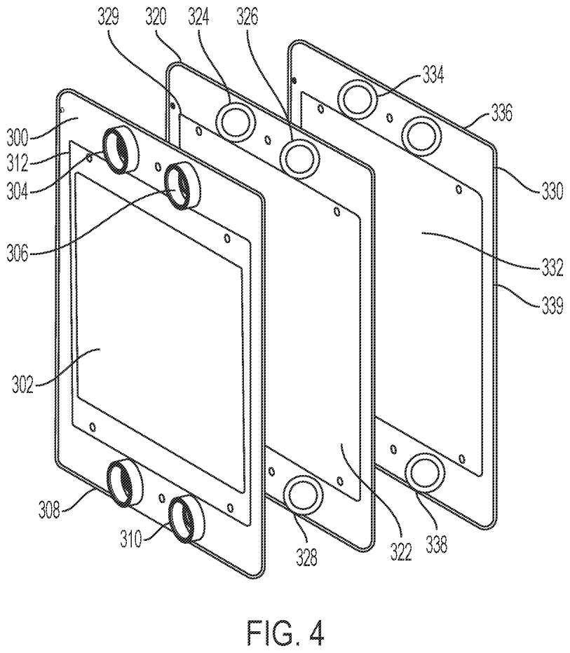

FIG. 4 provides a view (from the left side) of an arrangement of flow plate assemblies. As shown, a first frame 300 is engaged with a first flow plate to form a first flow plate assembly; the flow plate presents front surface 302. First frame (and/or other frames) can comprise two or more components that are assembled to form the final frame; e.g., a front portion and a back portion, which front portion and back portion are assembled about a flow plate so as to sandwich the flow plate therebetween. One or both of the front portion and the back portion can include channels, manifolds, and the like that are configured to distribute active material to channels formed in the flow plate.

A frame can comprise a non-conductive material, e.g., a thermoset or a thermoplastic, such as ABS.

Front surface 302 can comprise an arrangement of flow channels (not shown). As shown, first frame 300 includes upper apertures 304 and 306. Apertures 304 and 306 can serve as inlets and/or outlets for an active material fed to the assembly; such active materials can be negolytes or posolytes. First frame can also include apertures 308 and 310. Apertures 308 and 310 can serve as inlets and/or outlets for an active material fed to the assembly; such active materials can be negolytes or posolytes. A gasket 312 can be disposed on first frame 300; gasket 312 can seal the first flow plate assembly to a neighboring component, e.g., a wall, an electrode (e.g., a soft goods assembly electrode), another flow plate assembly, or other component.

As an example, an electrode (not shown) can be positioned between front surface 322 of the second flow plate and back surface 302a of the first flow plate. Such an electrode can be, e.g., a fabric or fibrous electrode; e.g., an electrode that is characterized as at least partially pervious or partially porous. In such an arrangement, one or both of the front surface 322 of the second flow plate and the back surface 302a of the first flow plate can contact the electrode. Alternatively, one or both of the front surface 322 of the second flow plate and the back surface 302a of the first flow plate can be close enough to the electrode that when one or both of the front surface 322 of the second flow plate and the back surface 302a of the first flow plate is wetted with an active material, the active material contacts the electrode. Put another way, the surface of the flow plate can be close enough to the electrode that the active material fills the gap between the surface and the electrode.

A flow plate (e.g., plate 302) can define a thickness in the range of from about 2 mm to about 10 mm. A frame (e.g., frame 320) can define a total thickness in the range of from about 2 mm to about 12 mm.

A second flow plate assembly is shown, which second flow plate assembly comprises second frame 320 and a second flow plate; the second flow plate presents front surface 322. Front surface 322 can comprise an arrangement of flow channels (not shown). Second frame 320 can include upper apertures 324 and 326, which can serve as inlets and/or outlets for an active material fed to the assembly; such active materials can be negolytes or posolytes. Second frame 320 can also one or more include lower apertures, illustrated by aperture 328. As shown, second flow plate assembly can include gasket 329. Gasket 329 can seal the second flow plate assembly to a neighboring component, e.g., a wall, an electrode, another flow plate assembly, or other component. The second flow plate assembly can be configured as a bipolar plate that receives two different active materials, though this is not a requirement. A bipolar plate can present each active material that it receives on a different surface of the bipolar plate, e.g., presenting a first active material received by the bipolar plate on one surface of the bipolar plate and a second active material received by the bipolar plate on the other surface of the bipolar plate.

An arrangement of flow plate assemblies can also include a third flow plate assembly; such an assembly can comprise a third frame 330 engaged with a third flow plate that presents front surface 332, which front surface can comprise an arrangement of flow channels (not shown). Third frame 330 can include upper features 334 and 336; these features can be, for example, apertures, but can also be dead ends for fluid that flows through apertures 324 and 326. Third frame 330 can also one or more include lower apertures, illustrated by aperture 338. Gasket 339 can seal the third flow plate assembly to a neighboring component, e.g., a wall, an electrode, another flow plate assembly, or other component. The third flow plate assembly can be configured as a bipolar plate that receives two different active materials, though this is not a requirement, as the third flow plate assembly can also be configured as a monopolar plate.

An arrangement can define one or more fluid loops for communication of active materials, such as electrolytes.

By reference to FIG. 4, a first loop can be formed whereby aperture 304 can receive a first active material (e.g., supplied by a pump from a source of that first active material), which first material is communicated to first flow plate front surface 302. The first active material can be further communicated to aperture 324 and then to second flow plate front surface 322. The first active material can be further communicated to upper feature 334 (which can be, e.g., a dead-end) and then to the third flow plate front surface 332. The first active material can then be communicated via lower feature 338, aperture 328, and aperture 310. In the case when a flow plate is a monopolar plate, active material is communicated to only one face of the plate, typically the face of the plate that faces an electrode.

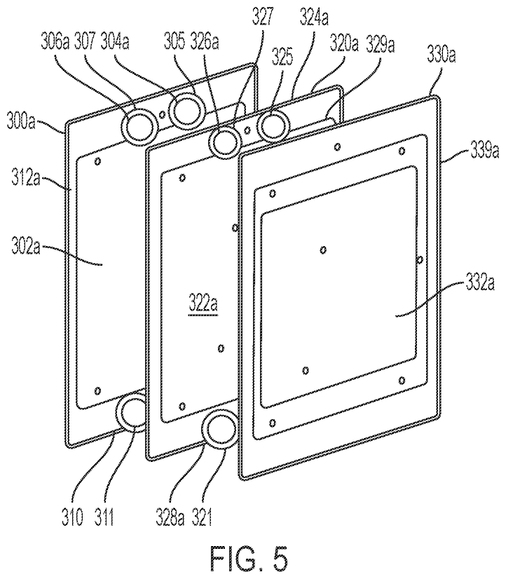

Similarly, a second loop can be formed whereby aperture 306 can receive a second active material (e.g., supplied by a pump from a source of that first active material), which first material is communicated to first flow plate back surface 302a (shown in FIG. 5). The second active material can be further communicated to aperture 326 and then to second flow plate back surface 322a (shown in FIG. 5). The second active material can be further communicated to upper feature 336 (which can be, e.g., a dead-end) and then to the third flow plate back surface 332a (shown in FIG. 5). The second active material can then be communicated via features (not shown) in the third and second frames and then via aperture 308.

Without being bound to any particular embodiment, an arrangement of flow plate assemblies can be configured such that first and second active materials are introduced to the arrangement from a first side (e.g, the front side) of the arrangement and that the first and second active materials are withdrawn or exit the arrangement from the first side. By reference again to FIG. 4, the first and second active materials can be introduced to the arrangement via apertures 304 and 306, respectively, and exit the arrangement via apertures 308 and 310, respectively. Alternatively, an active material can be introduced from one side (or end) of an arrangement and be withdrawn from the other side (or end) of the arrangement.

The foregoing loops are illustrative only, as a loop can be formed so as to utilize apertures different than the apertures described in the foregoing. For example, a loop that carries the first active material can use apertures 304 and 306 instead of apertures 304 and 310 (or apertures 304 and 308). As explained, the disclosed arrangements can thus comprise a first circulation loop (e.g., for a first active material) that is in fluidic isolation from a second circulation loop (e.g., for a second active material). A flow plate and/or a frame can include a channel and/or manifold (not shown) to collect active material that has passed along a channel of the flow plate. As an example, one or more of first frame 300 and the flow plate can include a channel and/or manifold to collect active material that has traversed a channel of the flow plate so as to direct that active fluid to an outlet. For example, active material may enter via aperture 304, traverse one or more channels of the flow plate, be collected by a manifold and/or channel of first frame 300 or the flow plate, and then be directed to an outlet, e.g., 310. Also as disclosed here, active material can be introduced toward one surface or face of a flow plate and then be distributed to channels on that same surface or to channels on the opposite surface of the flow plate.

FIG. 5 provides a view of the arrangement of flow plate assemblies from FIG. 4, but from the right side of the arrangement so as to show the back side of the assemblies. As shown, second frame 300a is engaged with a first flow plate to form a first flow plate assembly; the flow plate presents back surface 302a. Back surface 302a can comprise an arrangement of flow channels (not shown).

As shown, first frame 300a includes upper apertures 304a and 306a. Apertures 304a and 306a (which are, as shown, in register with apertures 304 and 306 of the first frame) can serve as inlets and/or outlets for an active material fed to the assembly; such active materials can be negolytes or posolytes. Also as shown, gaskets 305 and 307 can seal apertures 304a and 306a respectively. The second frame 300a can also include aperture 308a (not shown in FIG. 5) and aperture 310a, which apertures 308a and 310a are in register with apertures 308 and 310.

Aperture 308a can serve as an inlet and/or outlet for an active material fed to the assembly; such active materials can be negolytes or posolytes. A gasket 312a can be disposed on second frame 300a; gasket 312a can seal the first flow plate assembly to a neighboring component, e.g., a wall, an electrode, another flow plate assembly, or other component. Gasket 311 can seal aperture 310a. (A gasket, not shown, can also seal aperture 308a, also not shown in FIG. 5.)

A second flow plate assembly is shown, which second flow plate assembly comprises a second frame 320a and a second flow plate; the second flow plate presents back surface 322a. Back surface 322a can comprise an arrangement of flow channels (not shown).

Second frame 320a can include upper apertures 324a and 326a, which can serve as inlets and/or outlets for an active material fed to the assembly (and are in register with apertures 304a and 306a, respectively); such active materials can be negolytes or posolytes. Gaskets 325 and 327 can seal apertures 324a and 326a, respectively. Second frame 320a can also one or more include lower apertures, illustrated by aperture 328a. As shown, second flow plate assembly can include gasket 321. Gasket 321 can seal the second flow plate assembly to a neighboring component, e.g., a wall, an electrode, another flow plate assembly, or other component.

The second flow plate assembly can be configured as a bipolar plate that receives two different active materials, though this is not a requirement. A bipolar plate can present each active material that it receives on a different surface of the bipolar plate, e.g., presenting a first active material received by the bipolar plate on one surface of the bipolar plate and a second active material received by the bipolar plate on the other surface of the bipolar plate.

An arrangement of flow plate assemblies can also include a third flow plate assembly; such an assembly can comprise a second frame 330a engaged with a third flow plate that presents back surface 332a, which back surface can comprise an arrangement of flow channels (not shown). Gasket 339a can seal the first flow plate assembly to a neighboring component, e.g., a wall, an electrode, another flow plate assembly, or other component.

The third flow plate assembly can be configured as a bipolar plate that receives two different active materials, though this is not a requirement, as the flow plate assembly can also be configured as a monopolar plate.

A flow plate (and a frame associated with the flow plate) can be configured such that fluid delivered in a direction toward one surface of the flow plate can be distributed to flow channels on that surface of the flow plate and/or to flow channels on the other surface of the flow plate. As an example (and by reference to FIG. 4), fluid delivered to aperture 304 can be distributed to channels present on front surface 302 of the flow plate. Alternatively, fluid delivered to aperture 304 can be distributed to channels present on back surface 302a of that flow plate. In this way, the disclosed technology can allow a user to introduce fluid from one side of a flow plate while distributing that fluid to channels formed in the other side of that flow plate.

FIG. 6 (prior art; described elsewhere herein) provides an illustration of an exemplary flow battery.

### Aspects

The following Aspects are illustrative only and do not serve to limit the scope of the present disclosure or the appended claims.

Aspect 1. A flow plate assembly, comprising: a flow plate defining a plane, the flow plate comprising a moldable material having a conductive material dispersed therein, and the flow plate comprising one or more first channels configured to communicate a first electrolyte and optionally comprising at least a second channel configured to communicate a second electrolyte; a first frame; and a second frame; the first frame and the second frame being configured to engage with one another with the first frame being associated with a first face of the flow plate and the second frame being associated with a second face of the flow plate, the first frame defining an inlet port configured to communicate the first electrolyte, the first frame further comprising one or more channels and/or manifolds configured to communicate first electrolyte from the inlet port of the first frame to the first channel of the flow plate, and the first frame and the second fame being configured such that when engaged with one another, a portion of the first surface of the flow plate remains exposed.

First channels can be arranged in a variety of patterns. Suitable patterns will be known to those of ordinary skill in the art, and channels can be arranged according to the user's needs or the needs of a specific application. One or more of the first channels can be in fluidic isolation from one or more other of the first channels. Alternatively, one or more of the first channels can be in fluid communication with one another.

Channels can be straight, curved, or otherwise configured according to the user's needs. A first frame can include one or more apertures formed therein; such apertures can be in register with corresponding apertures formed in a second frame that mates to or is engaged with the first frame.

A variety of moldable materials can be used in the flow plates. As an example, a moldable material can comprise a metal, a conductive polymer, a, polymeric material having a conductive material disposed therein, and the like. Exemplary conductive materials include, e.g., metallic particles, metallic nanoparticles, carbon nanotubes (single- and multiwall), graphite, graphene, carbon fiber, and the like.

The first frame and second frame can be configured such that one or both of the first electrolyte and the second electrolyte are communicated to the first frame and second frame in a direction perpendicular to the plane of the flow plate, and the one or more channels and/or manifolds direct the flow of the electrolyte in the direction of the plane. Such channels and/or manifolds can be serpentine in configuration, as an example. The first frame and/or the second frame can themselves include one or more channels that is in register with a channel of the flow plate.

Aspect 2. The flow plate assembly of Aspect 1, wherein the flow plate comprises one or more second channels configured to communicate a second electrolyte.

Aspect 3. The flow plate assembly of any one of Aspects 1 to 2, wherein the one or more first channels lie generally in the plane of the flow plate or parallel to that plane and wherein the one or more first channels are formed in the first surface of the flow plate.

Aspect 4. The flow plate assembly of any one of Aspects 2 to 3, wherein the one or more second channels lie generally in the plane of the flow plate or parallel to that plane and wherein the one or more second channels are formed in the second surface of the flow plate.

Aspect 5. The flow plate of any one of Aspects 1 to 4, wherein the one or more first channels at least partially define a parallel arrangement of flow channels.

Aspect 6. The flow plate of any one of Aspects 2 to 4, wherein the one or more second channels at least partially defines a parallel arrangement of flow channels.

Aspect 7. The flow plate assembly of any one of Aspects 1 to 6, wherein the one or more first channels are formed in the material of the flow plate. Such forming can be accomplished by molding, pressing, coining, or other techniques known to those of ordinary skill in the art.

Aspect 8. The flow plate assembly of any one of Aspects 1 to 7, wherein the one or more first channels are defined by walls extending from the flow plate.

Aspect 9. The flow plate assembly of any one of Aspects 1 to 8, further comprising a current collector in electrical communication with the flow plate.

Aspect 10. The flow plate assembly of any one of Aspects 1 to 9, wherein the one or more channels or manifolds of the first frame are in register with at least the one or more first channels of the first plate.

Aspect 11. The flow plate assembly of any one of Aspects 1 to 10, wherein the one or more channels or manifolds of the first frame are configured to communicate a first electrolyte from a channel of the first face of the flow plate to another channel of the first face of the flow plate.

Aspect 12. The flow plate assembly of any one of Aspects 1 to 11, wherein the one or more first channels of the first face of the flow plate and the one or more channels or manifolds of the first frame together define a flow length through which first electrolyte flows, and wherein at least 10% of the flow length resides in the one or more channels and/or manifolds of the first frame.

Aspect 13. The flow plate assembly of Aspect 12, wherein at least 25% of the flow length resides in the one or more channels and/or manifolds of the first frame.

Aspect 14. The flow plate assembly of Aspect 13, wherein at least 50% of the flow length resides in the one or more channels and/or manifolds of the first frame.

Aspect 15. The flow plate assembly of Aspect 14, wherein at least 80% of the flow length resides in the one or more channels and/or manifolds of the first frame.

Aspect 16. An electrochemical cell stack assembly, comprising: at least two repeat units, a repeat unit comprising: (a) an electrode assembly, the electrode comprising a conductive fabric disposed within an electrode frame; (b) a first flow plate assembly, the first flow plate assembly comprising a first flow plate disposed within a first flow plate frame, the first flow plate defining a plane and comprising one or more channels configured to communicate a first electrolyte in the plane of the first flow plate or parallel to that plane; and (c) a second flow plate assembly, the second flow plate assembly comprising a second flow plate disposed within a second flow plate frame, the second flow plate defining a plane and comprising one or more channels configured to communicate a second electrolyte in the plane of the second flow plate or parallel to that plane, the electrode assembly being disposed between the first flow plate assembly and the second flow plate assembly such that the one or more channels of the first flow plate are disposed opposite to the one or more channels of the second flow plate assembly, the first flow plate frame and the second flow plate frame being superposed over the electrode frame and the repeat unit being arranged such that a pressure essentially perpendicular to the plane of the first flow plate and to the plane of the second flow plate maintains the first flow plate assembly, the electrode assembly, and the second flow plate assembly in position such that the conductive fabric is permeable to fluid flow.

As described elsewhere herein, a flow plate frame can comprise two pieces—e.g., a front piece and a back piece—that are assembled to form the completed frame. The pieces can be assembled so as to “frame” or sandwich the flow plate therebetween.

Aspect 17. The electrochemical cell stack assembly of Aspect 16, wherein the first flow plate frame comprises an inlet for introducing the first electrolyte.

Aspect 18. The electrochemical stack assembly of any one of Aspects 16 to 17, wherein the first flow plate frame comprises an outlet for withdrawing the first electrolyte.

Aspect 19. A method, comprising operating an electrochemical stack according to any one of Aspects 16 to 18 so as to store electrical energy.

Aspect 20. A method, comprising operating an electrochemical stack according to any one of Aspects 16 to 18 so as to provide electrical energy.

Aspect 21. An electrochemical cell stack, the electrochemical cell stack comprising a plurality of flow plate assemblies according to any one of Aspects 1 to 15.

Aspect 22. A method, comprising operating an electrochemical cell stack according to Aspect 21 so as to store electrical energy.

Aspect 23. A method, comprising operating an electrochemical stack according to Aspect 21 so as to provide electrical energy.

1. A flow plate assembly, comprising:
a flow plate defining a plane,
the flow plate comprising a moldable material having a conductive material dispersed therein, and
the flow plate comprising one or more first channels configured to communicate a first electrolyte and optionally comprising at least a second channel configured to communicate a second electrolyte;
a first frame; and
a second frame;
the first frame and the second frame being configured to engage with one another with the first frame being associated with a first face of the flow plate and the second frame being associated with a second face of the flow plate,
the first frame defining an inlet port configured to communicate the first electrolyte,
the first frame further comprising one or more channels or manifolds configured to communicate first electrolyte from the inlet port of the first frame to the first channel of the flow plate, and
the first frame and the second fame being configured such that when engaged with one another, a portion of the first surface of flow plate remains exposed.

2. The flow plate assembly of claim 1, wherein the flow plate comprises one or more second channels configured to communicate a second electrolyte.

3. The flow plate assembly of claim 1, wherein the one or more first channels lie generally in the plane of the flow plate or parallel to that plane and wherein the one or more first channels are formed in the first face of the flow plate.

4. The flow plate assembly of claim 2, wherein the one or more second channels lie generally in the plane of the flow plate or parallel to that plane and wherein the one or more second channels are formed in the second face of the flow plate.

5. The flow plate of claim 1, wherein the one or more first channels at least partially define a parallel arrangement of flow channels.

6. The flow plate of any one of claim 2, wherein the one or more second channels at least partially defines a parallel arrangement of flow channels.

7. The flow plate assembly of claim 1, wherein the one or more first channels are formed in the material of the flow plate.

8. The flow plate assembly of claim 1, wherein the one or more first channels are defined by walls extending from the flow plate.

9. The flow plate assembly of claim 1, further comprising a current collector in electrical communication with the flow plate.

10. The flow plate assembly of claim 1, wherein the one or more channels or manifolds of the first frame are in register with at least the one or more first channels of the first plate.

11. The flow plate assembly of claim 1, wherein the one or more channels or manifolds of the first frame are configured to communicate a first electrolyte from a channel of the first face of the flow plate to another channel of the first face of the flow plate.

12. The flow plate assembly of claim 1, wherein the one or more first channels of the first face of the flow plate and the one or more channels or manifolds of the first frame together define a flow length through which first electrolyte flows, and wherein at least 10% of the flow length resides in the one or more channels or manifolds of the first frame.

13. The flow plate assembly of claim 12, wherein at least 25% of the flow length resides in the one or more channels or manifolds of the first frame.

14. (canceled)

15. (canceled)

16. An electrochemical cell stack assembly, comprising:
at least two repeat units, a repeat unit comprising:
(a) an electrode assembly, the electrode comprising a conductive fabric disposed within an electrode frame;
(b) a first flow plate assembly,
the first flow plate assembly comprising a first flow plate disposed within a first flow plate frame, the first flow plate defining a plane and comprising one or more channels configured to communicate a first electrolyte in the plane of the first flow plate or parallel to that plane; and
(c) a second flow plate assembly,
the second flow plate assembly comprising a second flow plate disposed within a second flow plate frame, the second flow plate defining a plane and comprising one or more channels configured to communicate a second electrolyte in the plane of the second flow plate or parallel to that plane,
the electrode assembly being disposed between the first flow plate assembly and the second flow plate assembly such that the one or more channels of the first flow plate are disposed opposite to the one or more channels of the second flow plate assembly,
the first flow plate frame and the second flow plate frame being superposed over the electrode frame and the repeat unit being arranged such that a pressure essentially perpendicular to the plane of the first flow plate and to the plane of the second flow plate maintains the first flow plate assembly, the electrode assembly, and the second flow plate assembly in position such that the conductive fabric is permeable to fluid flow.

17. The electrochemical cell stack assembly of claim 16, wherein the first flow plate frame comprises an inlet for introducing the first electrolyte.

18. The electrochemical cell stack assembly of claim 16, wherein the first flow plate comprises an outlet for withdrawing the first electrolyte.

19. A method, comprising operating an electrochemical stack according to claim 16 so as to store or provide electrical energy.

20. (canceled)

21. An electrochemical cell stack, the electrochemical cell stack comprising a plurality of flow plate assemblies according to claim 1.

22. A method, comprising operating an electrochemical cell stack according to claim 21 so as to store electrical energy.

23. A method, comprising operating an electrochemical stack according to claim 21 so as to provide electrical energy.
